(19) United States
(12) Patent Application Publication
(10) Pub. No.: US 2015/0027013 A1
(43) Pub. Date: Jan. 29, 2015

(54) ARTICULATED RING SET

(71) Applicant: Janick Simeray, Argenteuil (FR)

(72) Inventor: Janick Simeray, Argenteuil (FR)

(21) Appl. No.: 14/180,956

(22) Filed: Feb. 14, 2014

Related U.S. Application Data
(60) Provisional application No. 61/858,617, filed on Jul. 26, 2013.

(51) Int. Cl. G09F 19/02

(52) U.S. Cl. CPC G09F 19/02
USPC 40/409

(57) ABSTRACT

An articulated ring set includes a plurality of concentric rings connected by axles having axes of rotation that are perpendicular to the axes of symmetry of the rings. The axles are angularly offset from one another such that they are non-orthogonal and non-parallel to one another. In an embodiment, some of the rings define a race and the axles coupling the rings to other rings of the pluralit of concentric rings are slidable within the race. First and second coils may be positioned within an innermost ring and coupled to a circuit that senses current in one coil and, in response, induces a current in the other coil. Magnets in one or more other rings both induce current in the coils and are accelerated by current in the coils.

### PRIORITY CLAIM

This invention claims benefit to provisional application No. 61/858,617 filed Jul. 26, 2013.

### FIELD OF THE INVENTION

This invention pertains generally to the field of brain teaser and specialty gifts and toys.

### BACKGROUND OF THE INVENTION

A ball, known on the market as “®Power Ball” is an exerciser for the wrist, in which a rotational movement of the wrist is converted into a high rotational speed of a gyroscope increasing dramatically its apparent inertia. A Galilean cannon is a device that demonstrates conservation of linear momentum. It comprises a stack of balls, starting with a large, heavy ball at the base of the stack and progresses up to a small, lightweight ball at the top. The basic idea is that this stack of balls can be dropped to the ground and almost all of the kinetic energy in the lower balls will be transferred to the topmost ball, which will rebound to many times the height from which it was dropped. There is a modern version of this, known as ®Astro Blaster.

### SUMMARY OF THE INVENTION

In the spirit of the two items mentioned above, the present invention is a device comprising for example rings of decreasing sizes interconnected by axes, and converts a rotation of the wrist holding the device into rotation of the interconnected rings of decreasing sizes in direction and speed depending from the instant state of the connection. This creates a visual animation, an attraction, and an excitement involving dexterity and concentration.

In one aspect of the invention, a plurality of concentric rings define a plurality of adjacent ring pairs each including an inner ring and an outer ring having an inner diameter greater than an outer diameter of the inner ring such that the inner ring is inserteable and rotatable within the outer ring. A plurality of axle pairs are each associated with an adjacent ring pair. Each axle pair includes first and second axles positioned on opposite sides of the inner ring of the adjacent ring pair and defining an axis of rotation. The first and second axles rotatably couple the inner ring to the outer ring of the adjacent ring pair. The axis of rotation of the axle pair being perpendicular to axes of symmetry of both the inner and outer rings of the adjacent ring pair. The axes of rotations of the plurality of axle pairs are at non-orthogonal and non-parallel angles with respect to one another. For example, the axis of rotation of each axle pair of the plurality of axle pairs defines an angle between 10 and 80 degrees with respect to the axes of rotation all other axle pairs of the plurality of axle pairs.

In some embodiments, an innermost ring of the plurality of concentric rings further includes a first coil and a second coil wound about an axis that is perpendicular to both the axis of symmetry of the innermost ring and the axis of rotation of an axle pair of the plurality of axle pairs rotatably coupled to the innermost ring. A circuit is electrically coupled to the first and second coil and including electrical components effective to sense current induced in the first coil and, in response to sensing current induced in the first coil, generate a corresponding current in the second coil. A second-most inward ring of the plurality of concentric rings includes magnets positioned to induce current in the first coil responsive to rotation of the second-most inward ring relative to the innermost ring. The first and second coils may be wound in opposite direction.

An outermost ring of the pluraity of rings may be coupled to a stand or handle. The handle may incorporate a light source for illuminating the plurality of rings and a motor for oscillating the outermost ring with respect to the handle or stand. The motor or light source may be controlled by a controller that implements an alarm clock or motion senitive activatio not the motor or light source.

In another embodiment, some of the rings define a race in which a ring is positioned. Axles rotatably couple the rings to others of the rings such that the axes of rotation about the axles can slide within the race.

Corresponding methods of use are also disclosed and claimed herein.

### BRIEF DESCRIPTION OF THE DRAWINGS

Preferred and alternative examples of the present invention are described in detail below with reference to the following drawings:

FIGS. 1A and 1B are isometric views of an articulated ring set in accordance with an embodiment of the present invention;

FIG. 2 is an exploded view of an alternative embodiment of an articulated ring set in accordance with an embodiment of the present invention;

FIG. 3 is a cross-sectional view of the articulated ring set of FIG. 2;

FIGS. 4A and 4B are isometric view of another embodiment of an articulated ring set in accordance with an embodiment of the present invention;

FIG. 5A is an isometric view of yet another embodiment of an articulated ring mounted on a stand in accordance with an embodiment of the present invention;

FIG. 5B is a front elevation view of the embodiment of FIG. 5A;

FIG. 6A is an isometric view a ring set enclosed within a sphere in accordance with an embodiment of the present invention;

FIG. 6B is a front elevation view of the embodiment of FIG. 6A;

FIG. 7 is a is a schematic view of a circuit for actuating articulated rings in accordance with an embodiment of the present invention; and

FIG. 8 is a schematic view of articulated rings including an actuation mechanism in accordance with an embodiment of the present invention.

### DETAILED DESCRIPTION OF THE PREFERRED EMBODIMENT

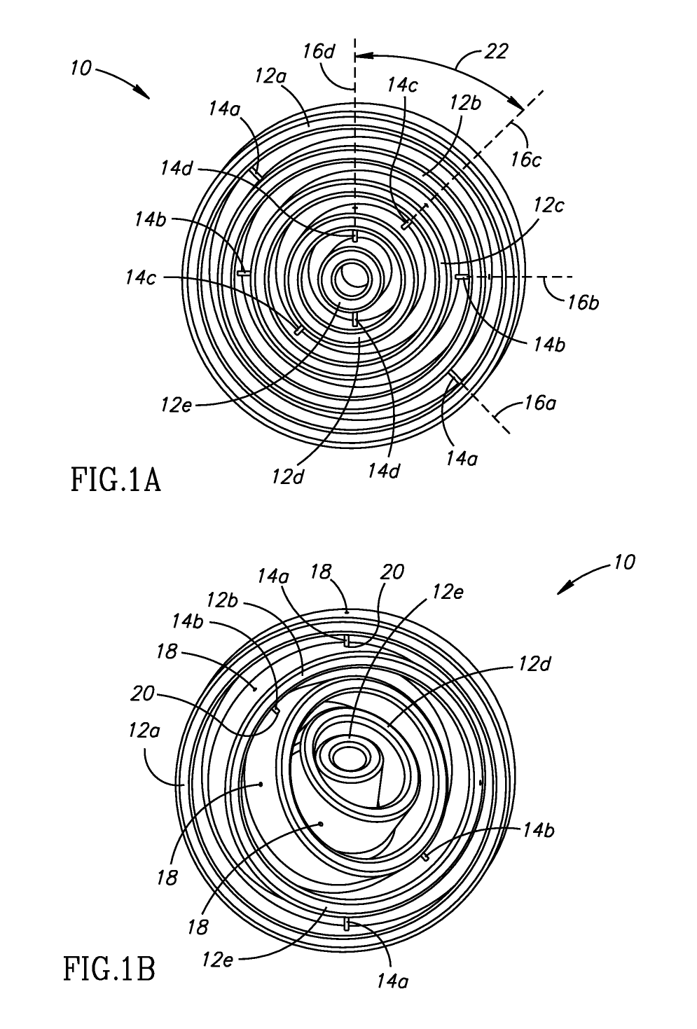

Referring to FIGS. 1A and 1B, a ring set 10 may include a plurality of rings 12a-12e. In the illustrated embodiment, five rings 12a-12e are shown, but other numbers of rings may be used, such as from three to ten, or more, rings. Each ring 12b-12e has an outer diameter sized to both fit within an inner diameter of the next largest ring 12a-12d and be rotatable when positioned within the inner diameter of the next largest ring 12a-12d. In particular, for an adjacent pair of rings (e.g., 12a and 12b, 12b and 12c, etc.) the larger ring may have an inner diameter and the smaller ring may have an outer diameter that permits spinning of the smaller ring about an axis perpendicular to the axes of symmetry of either the larger or smaller ring.

As is apparent, in one embodiment the outer and inner surfaces of the rings 12a-12e are cylinders, i.e., are parallel to the axis of symmetry of the rings 12a-12d. Accordingly, rotation of a ring 12b-12e within an adjacent outer ring 12a-12d may require a gap between the outer surface of the ring and the adjacent outer ring sufficient to allow for revolution of the ring about an axis of rotation parallel to the axis of symmetry of the ring.

A ring 12b-12e that is positioned within an adjacent outer ring 12a-12d may be rotatably coupled thereto by means of one or more axles 14a-14d. For example, ring 12a may be coupled to ring 12b by one or more axles 14a, ring 12b may be coupled to ring 12c by one or more axles 14b, and so on. A pair of axles 14a may lie on and define a common axis of rotation 16a. The axle pairs 14b-14d may also define corresponding axes of rotation 16b-16d. Each axle, or axle pair, of the axles 14a-14d may be rotatably coupled to an inner ring and fixedly coupled to an outer ring that is coupled by the each axle to the inner ring or fixedly coupled to the inner ring and rotatably coupled to the outer ring that is coupled by the each axle to the inner ring. Likewise each axle, or axle pair, of the axles 14a-14d may be rotatably coupled to both the inner ring and outer ring rotatably coupled thereby.

The axles 14a-14d may be rotatably coupled to the inner and outer rings coupled thereby by any means known in the art. For example, the axles 14a-14d may be no more than pins inserted within each of the inner and outer rings coupled thereby, either with or without a lubricant. Axles 14a-14d may be coupled to one or both of the inner and outer rings coupled thereby by means of bearings, including any bearing known in the art. In some embodiments, a pair of adjacent rings coupled by an axle 14a-14d, or pair of axles 14a-14d, may be defined by inserting the axle 14a-14d through an aperture 18 in the outer ring and into engagement with the inner ring. The axle 14a-14d may insert within an aperture 20 that extends completely or only partially through the inner ring. In some embodiments, the aperture 18 extends partially through the outer ring from an inner surface of the outer ring. In some embodiments, one of the apertures 18, 20 defines a press fit with the axle 14a-14d, or is otherwise affixed to the axle 14a-14d, and the other of the apertures 18, 20 permits free rotation of the axle 14a-14d when inserted therein.

Each axis of rotation 16a-16d defined by each axle 14a-14d, or pair of axles 14a-14d, may be offset from every other axis of rotation 16a-16d by an angle 22. For example, the illustrated angle 22 defines an angular separation between axis of rotation 16d and axis of rotation 16c. In some embodiments, the angular separation 22 between an axis of rotation 16a-16d and each other axis of rotation 16a-16d is non-orthogonal and non-perpendicular. In particular, the angle 22 between one axis of rotation 16a-16d and each and every other of the axes of rotation 16a-16d may be between 10 and 80 degrees.

Providing axis of rotation 16a-16d having non-orthogonal separation angles 22 facilitates use of the ring set 10. By shaking the outer ring 12a, the movement is transferred to the inner rings 12b-12e, which may then continue to rotate in an apparently random fashion due to the irregular orientation of the axes of rotation 16a-16d.

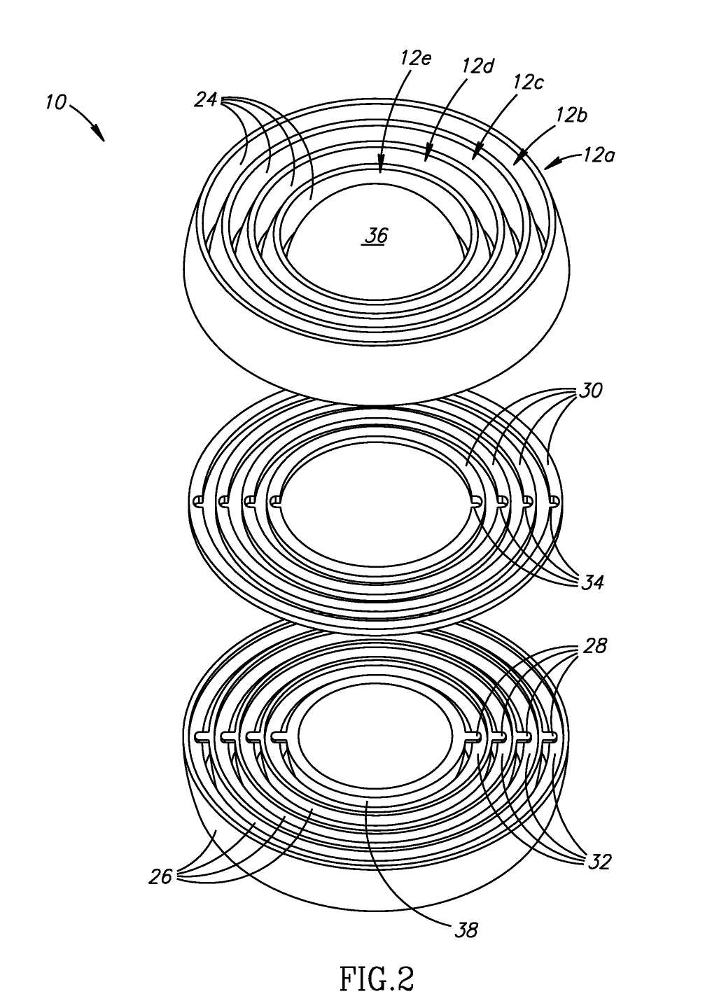

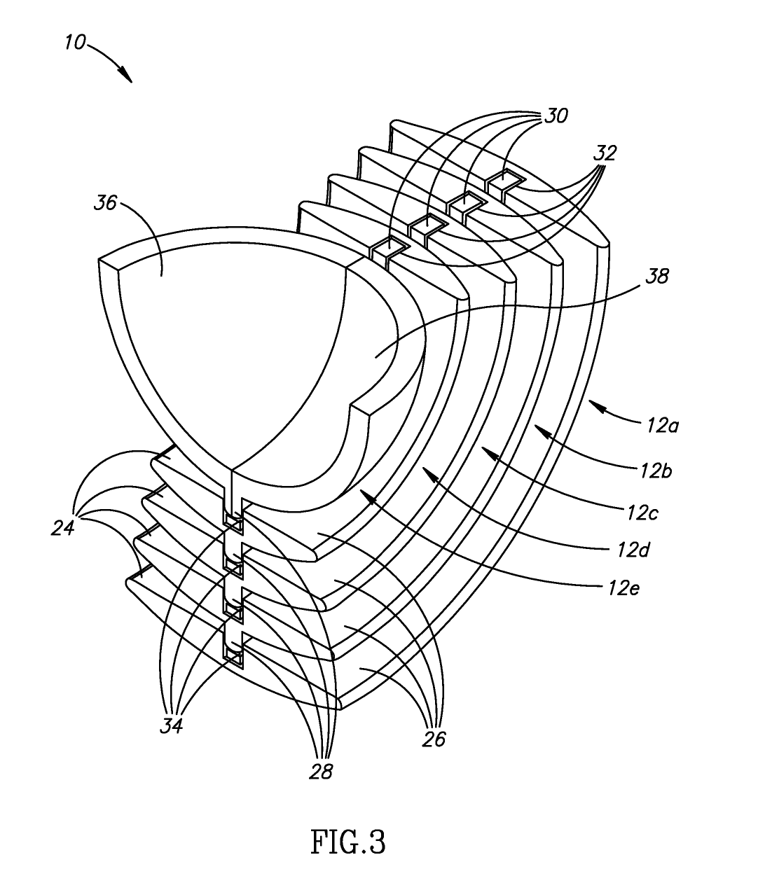

Referring to FIGS. 2 and 3, in some embodiments rings of a ring set 10 may be both rotatable and slidable with respect to one another. For example, a ring set 10 may include a plurality of rings 12a-12e formed by a concentric plurality of upper ring portions 24 and a concentric plurality of lower ring portions 26. Each upper ring portion 24 mates with a lower ring portion 26 to define one of the rings 12a-12e of the ring set 10. Some of the upper and lower ring portions 24, 26 may define axle stubs 28, such as protruding outwardly from all but the outermost ring 12a or protruding inwardly from all but the innermost ring 12e. The illustrated axle stubs 28 are shown for the lower ring portions 26. The upper ring portions 24 may be identically configured to the lower ring portions. The axle stub 28 of an upper ring portion 24 may mate with an axle stub 28 of a lower ring portion 26 to define a cylindrical axle. As shown, the axle stubs 28 may include planar surfaces to permit mating of axle stubs 28 of the upper and lower ring portions 24, 26. Alternatively, a cylindrical axle stub 28 may mount to only one of a mated pair of upper and lower ring portions 24, 26.

Some of the upper and lower ring portions 24, 26 may define a ring seat 32 for receiving a ring 30. The ring seat 32 may be defined in both of the upper and lower ring portions 24, 26, only the upper ring portions 24, or only the lower ring portions 26. When the upper and lower ring portions 24, 26 are mated to one another having the ring 30 positioned within the ring seat 32, the ring is rotatable within the ring seat 32. Accordingly, an axial width of the ring seat 32 may be greater than the axial thickness of the ring 30 and the diameter of the ring seat 32 may be greater than an outer diameter of the ring 30 in order to facilitate free rotation of the ring 30 within the seat 32. The ring 30 may be made of a low friction material such as polyamide Polyoxymethylene (POM), or the like.

The ring 30 may include notches 34 or holes 34 for rotatably receiving the axle stubs 28. Accordingly, an inner set of upper ring portion 24 and lower ring portion 26 may define axle stubs 28 that insert within the notches 34 of a ring 30 and the ring seat 32 of an adjacent outer set of upper ring portion 24 and lower ring portion 26. In some embodiments, the opposite may be the case, the inner set of upper ring portion 24 and lower ring portion 26 may define a seat 32 for receiving the ring 30 and an adjacent outer set of upper ring portion 24 and lower ring portion 26 may define axle stubs 28 inserting within notches 34 in the ring 30.

In the embodiment of FIGS. 2 and 3, the innermost ring 12e may be embodied as a sphere 12e, such as a sphere 12e defined by upper and lower sphere portions 36, 38 that may be coupled to one another to form a sphere. The sphere portions 36, 38 may define axle stubs 38 or ring seat 32 in a same manner as the upper and lower ring portions 24, 26 discussed above. And may be coupled to an adjacent outer set of upper and lower ring portions 24, 26 by means of the axle stubs 38 thereof, or by engagement of the sphere portions 36, 38 with axle stubs of the adjacent outer set of upper and lower ring portions 24, 26.

The sliding of the axle stubs 38 along the ring seat 32 may advantageously allow precession induced by each twist of the outermost ring portions 24, 26 to accelerate the rotational speed of inner ring portions 24, 26 and increase their gyroscopic momentum as kinetic energy is transferred inwardly from ring to ring.

In the embodiment of FIGS. 1A and 1B, the rings 12a-12e are cylindrical, including a cylindrical center ring 12e. In the embodiment of FIGS. 2 and 3, the rings 12a-12e are curved in a plane including the axis of symmetry (i.e. a plane in which the axis of symmetry lies) as well as being round in a plane perpendicular to the axis of symmetry (e.g., circular). As is apparent in FIG. 3, the outer surface of a ring 12a-12e has a convex shape in a plane including the axis of symmetry of the ring 12a-12e. In this embodiment, the inner surfaces of rings 12a-12e are flat in a plane including the axis of symmetry in the illustrated embodiment. In other embodiments, the inner surfaces of the rings 12a-12e are concave in a plane including the axis of symmetry. The convex outer surfaces and concave inner surfaces of the rings 12a-12d may be sections of a spherical surface such that gap between adjacent pairs of rings 12a-12e may be reduced inasmuch as the surfaces conform to a spherical path described by rotating a ring.

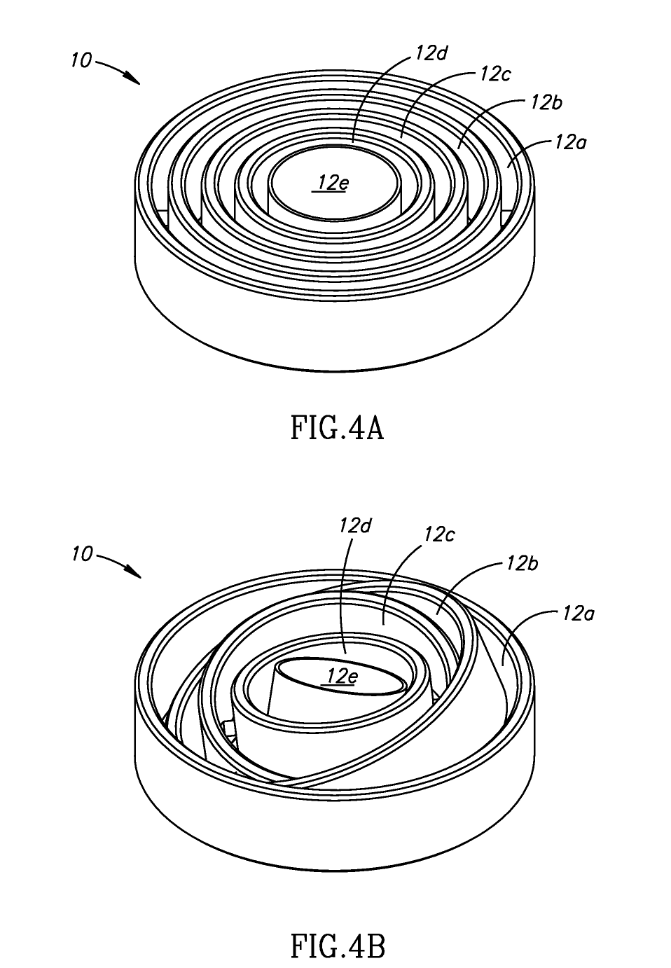

Referring to FIGS. 4A and 4B, in some embodiments, the rings 12a-12b may be chamfered cylinders having straight sides, e.g. inner and outer surfaces that are straight in a plane including the axis of symmetry. In the embodiments, of FIGS. 4A and 4B, the innermost ring 12e is embodied as a solid cylinder, e.g. drum-shaped.

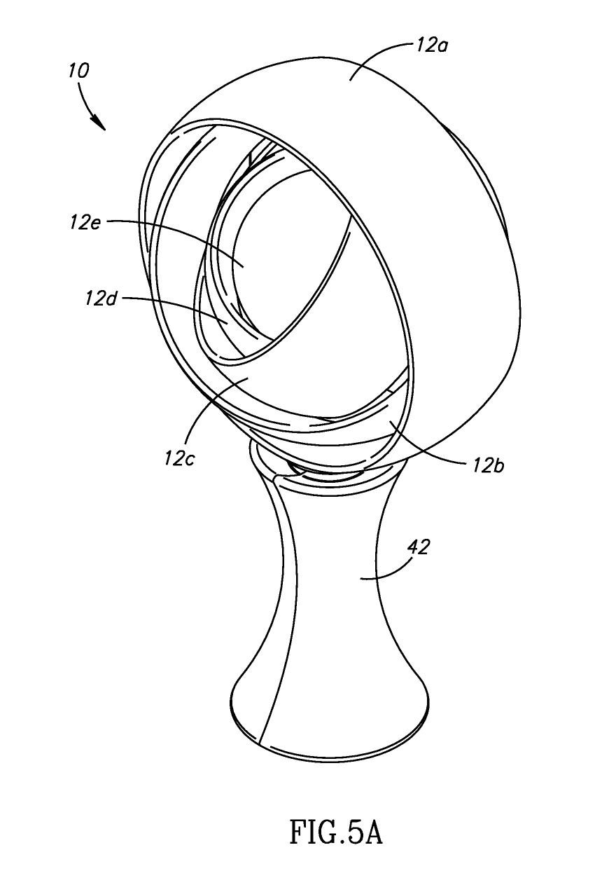

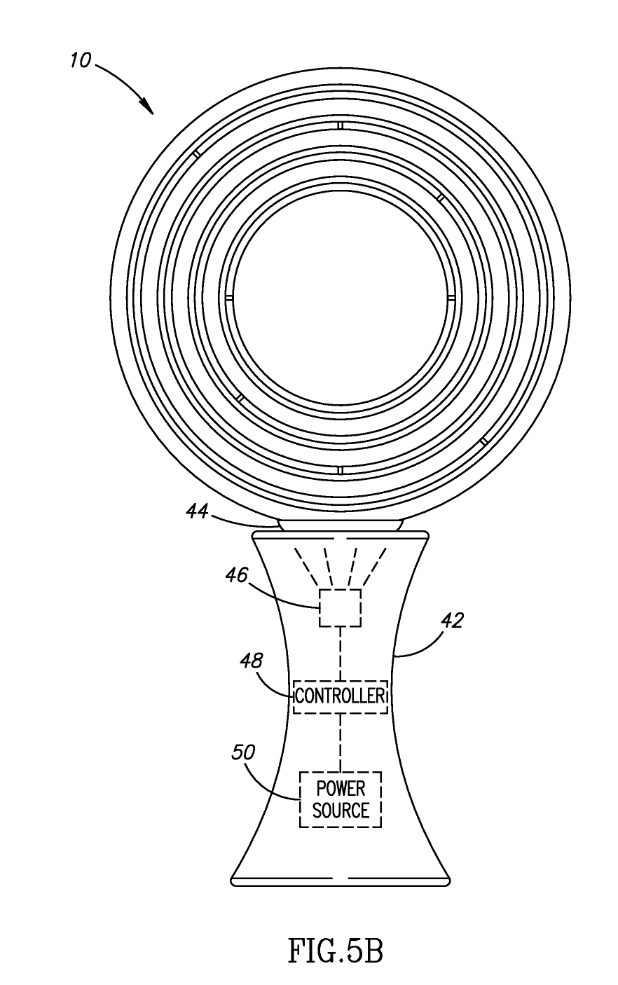

Referring to FIGS. 5A and 5B, in some embodiments, the rings 12a-12e according to any of the preceding embodiments may be mounted to a stand or handle 42. The stand 42 may have a suction cup 44 affixed to a proximal end thereof for securing to a smooth outer surface of the ring 12a. Other fastening means may also be used. For example, the ring 12a may define an aperture for receiving a fastener (e.g. screw) passing therethrough and affixing to the stand 42. A distal end of the stand may be flat such that the stand may be placed upright on a supporting surface.

The stand 42 may include a light source 46, such as one or more light emitting diodes (LED) that direct light onto the ring set 10. A proximal surface of the stand interfacing with the ring 12a and the suction cup 44 may be transparent, translucent, or perforated with one or more holes, to enable this light to reach the ring set 10. The rings 12a-12e may be transparent or translucent with embedded coloring and/or scattering reflective elements embedded therein to provide a decorative appearance. The light source 46 may include a variety of light sources having different colors that may be activated in sequence to provide a time-varying light show.

The light source 46 may be coupled to a controller 48 that is also coupled to a power source 50 such as a battery or an adapter coupled to an electrical outlet. The controller 48 may include circuits that control the supply of power from the power source 50 to the light source 46. For example, the controller may be coupled to a simple user-operated switch whereby a user may close a circuit and couple power to the light source 46. The controller 48 may include a motion sensor such that upon sensing motion of the stand 42, the controller 48 couples power from the power source 50 to the light source 50. The controller 48 may include a timer and circuits that decouple the power source 50 from the light source 46 upon occurrence of the absence of detected movement, e.g. movement exceeding some threshold, by the motion sensor for a predetermined time period. The controller 48 may activate differently colored light sources at different times to provide a colorful time-varying display.

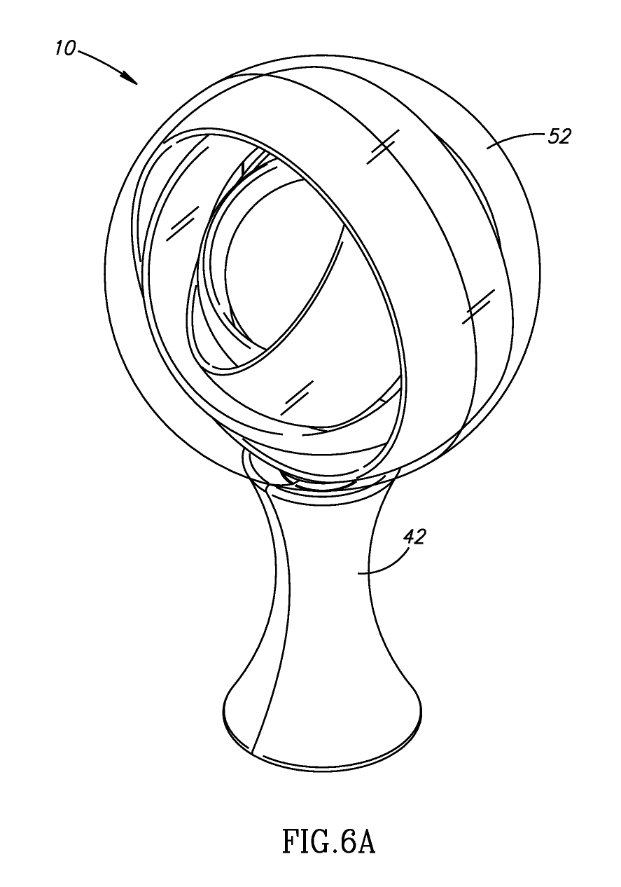

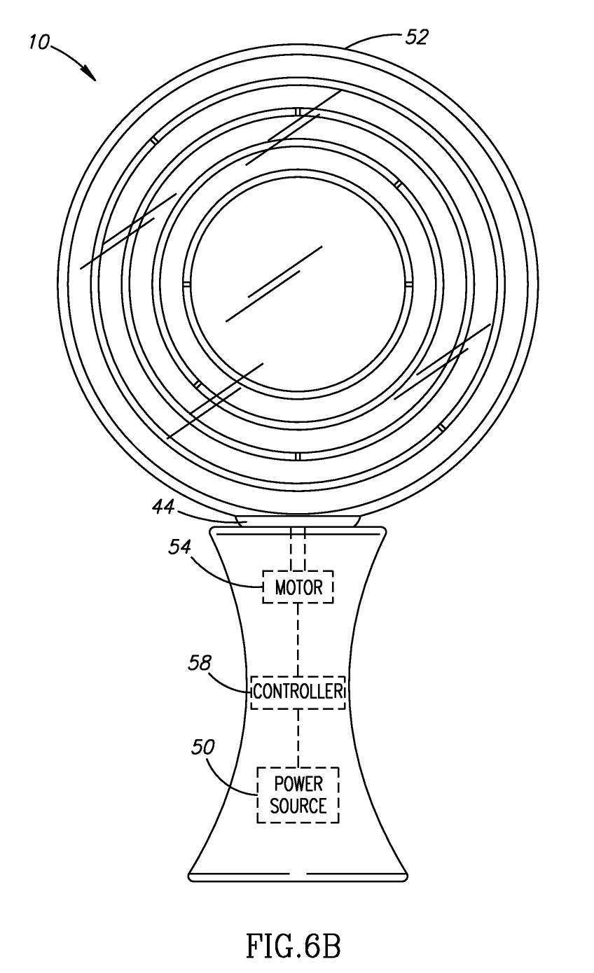

Referring to FIGS. 6A and 6B, in some embodiments, the rings 12a-12e of the ring set 10 may mounted within a transparent or translucent sphere or envelope 52. The sphere 52 may include two sections that may be secured around the rings 12a-12e. The sections may be removably secured to one another such that the rings 12a-12e may be removed and used without the sphere. The ring set 10 of FIGS. 6A and 6B may be any of the ring sets described herein.

In some embodiments, the suction cup 44 of the stand 42 may also secure or be securable to the sphere 52. In some embodiments, the stand 42 may incorporate a motor 54, such as a motor 54 coupled to the suction cup 44, directly to the sphere 52, or to the outer ring 12a by means of the suction cup 44 or some other fastening means. The controller 48 may be operably coupled to the motor. Although not shown in FIG. 6B, the controller 48 may also be coupled to a light source 46 as in the embodiment of FIGS. 5A and 5B.

The controller 48 may couple power from the power source 50 to the motor 54 upon closing of a user-operated switch, upon detecting motion by means of a motion sensor, or upon triggering of an alarm. For example, the controller 48 may implement an alarm clock as known in the art and include an interface for receiving a set time for an alarm and for setting a current time. The controller 48 may include circuits that receive the set time and current time and store them. The controller 48 may be coupled to a display for displaying a current time and/or other information for describing the state of an alarm clock as known in the art. The controller 48 may have circuits that detect occurrence of the set time and, in response, couple power to the motor 54 in order to shake or rotate the sphere 52 or the outer ring 12a. For example, upon occurrence of the set time, the controller 48 may cause the motor to oscillate the sphere 52 or outer ring 12a (e.g. back and forth two, three, or more times). This may set the inner rings 12b-12e in motion. The controller 48 may further include circuits that couple power to the light source 46 upon occurrence of the set time in order to illuminate the rings as they spin.

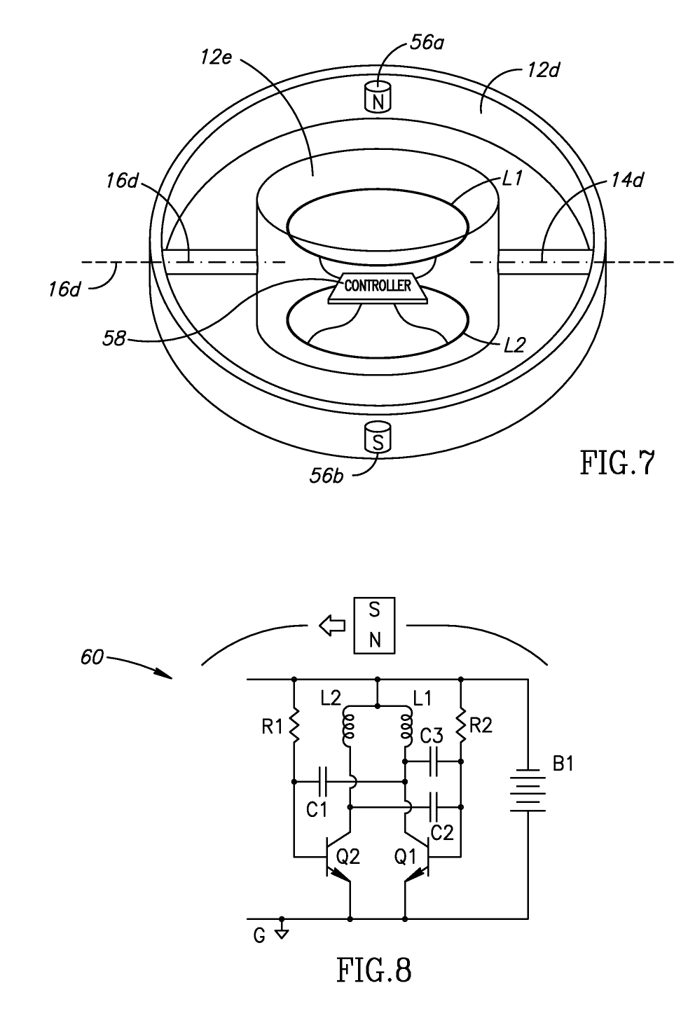

Referring to FIGS. 7, in some embodiments one or more of the rings 12a-12b may include one or more magnets 56a, 56b. For example, the second-most inward ring 12d and one or more other outer rings may include magnets 56a, 56b. As shown in FIG. 7, the magnets 56a, 56b may be offset 90 degrees from the axles 14d coupling the ring 12d to the ring 12e and may be on opposite sides of the ring 12d from one another. In particular, the magnets 56a, 56b may be equally angularly offset from both of the axles 14d, or from the axis of rotation 16d defined by the axles 14d. Where one or more of the other rings 12b-12c include one or more magnets 56a, 56b, these magnets 56a, 56b may likewise be offset from the corresponding axes of rotations 16b-16c of these rings.

Where two magnets 56a, 56b are used, the polarity of the magnets 56a, 56b may be aligned, e.g., the north to south axis of one magnet 56a, 56b may have the same direction and opposite orientation of the north to south axis of the other magnet 56a, 56b. A central ring 12e may include one or more coils L1, L2 that are operable to one or both of induce magnetic fields incident on the magnets 56a, 56b and detect fields induced by the magnets 56a, 56b. The magnets 56a, 56b may be at a radial position with respect to the coils L1, L2 such that at some point in rotation of the ring 12d with respect to the ring 12e, the magnets are close enough to the coils L1, L2 to be accelerated thereby.

The coils L1, L2 may be wound in opposite directions about a winding axis that is perpendicular to both an axis of symmetry of the ring 12e and the axis of rotation 16d of the axles 14d. That is to say, the current in one coil L1 may circulate in one direction, e.g., clockwise with reference to FIG. 7, whereas current in the other coil L2 circulates in an opposite direction, e.g., counter clockwise with reference to FIG. 7. Current in the coils L1 and L2 may be sensed and induced by a controller 58.

Referring to FIG. 8, the coils L1 and L2 may be modeled as inductors within the circuit 60 shown in FIG. 8. The circuit of FIG. 8 may be incorporated into the controller 58. As shown, one terminal of each of the coils is coupled to a power source, such as battery B1 or an output of an adapter. The other terminals of the coils L1 and L2 are coupled to the drains of transistors Q1 and Q2, respectively. The other terminal of the coils L1 and L2 are also coupled to a terminal of capacitors C1 and C2, respectively. The other terminals of the capacitors C1 and C2 are coupled to the gates of the transistors Q2 and Q1, respectively. The other terminals of capacitors C1 and C2 are also coupled by capacitors R1 and R2, respectively, to the power source B1. The sources of the transistors Q1 and Q2 are coupled to ground G.

In some embodiments, to discourage spontaneous oscillations at high frequencies, capacitor C3 may couple one of the coils, e.g1 L1, to a terminal of capacitor C2. The capacitor C3 may be much smaller, e.g., less than 10%, of the capacitor C2 in order to avoid disrupting the operation of the circuit.

In operation, a magnet 56a induces a current in the coil L1, which charges capacitor C1 and, upon charging the capacitor C1 to a voltage above the threshold voltage of the capacitor Q2, the transistor Q2 allows current to flow from the power source B1 through the coil L2 to ground G. The current through coil L2 repels the magnet 56 as it passes thereover, or the other magnet 56b thereby reinforcing the movement sensed by coil L1. The sizes of the capacitors C1, C2 and the inductance of the coils L1 and L2 may be chosen to generate a repulsive force at an appropriate time after sensing such that the magnets 56a, 56b are accelerated.

In a similar manner, current induced by a magnet 56a in the coil L2 charges capacitor C2, which will then apply a voltage to the gate of transistor Ql, thereby allowing current to flow through coil L1 to ground G and inducing a reinforcing force on the magnet 56a or the magnet 56b.

The circuit 60 may be turned on and off by the controller 58, such as by decoupling it from the power source B1. For example, a motion sensor in the controller 58 may sense movement of the ring 12e. Upon sensing movement, the controller 58, may couple the circuit of FIG. 8 to the power source B1. A user may hold the rings and prevent further movement of the rings of the ring set, e.g. movement of the ring 12d with respect to the ring 12e.

Upon sensing this lack of movement using the movement sensor, the controller 58 may then again decouple the circuit 60 from the power source B1. Likewise, the controller 58 may incorporate a timer and decouple the circuit 60 from the power source B1 N minutes (e.g., five) after the movement detected by the motion sensor triggered the controller 58 to couple the circuit 60 to the power source B1.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An apparatus comprising:
a plurality of concentric rings defining a plurality of adjacent ring pairs each including an inner ring and an outer ring having an inner diameter greater than an outer diameter of the inner ring such that the inner ring is insertable and rotatable within the outer ring;
a plurality of axle pairs, each axle pair associated with an adjacent ring pair and including first and second axles positioned on opposite sides of the inner ring of the adjacent ring pair and defining an axis of rotation, the first and second axles rotatably coupling the inner ring to the outer ring of the adjacent ring pairs, the axis of rotation being perpendicular to axes of symmetry of both the inner and outer rings;
wherein the axes of rotations of the plurality of axle pairs are at non-orthogonal and non-parallel angles with respect to one another.

2. The apparatus of claim 1, wherein the axis of rotation each axle pair of the plurality of axle pairs defines an angle between 10 and 80 degrees with respect to the axes of rotation all other axle pairs of the plurality of axle pairs.

3. The apparatus of claim 1, wherein an innermost ring of the plurality of concentric rings is defined by an outer surface of sphere.

4. The apparatus of claim 1, wherein an innermost ring of the plurality of concentric rings is defined by a cylindrical outer surface of a closed-ended cylinder.

5. The apparatus of claim 1, wherein an innermost ring of the plurality of concentric rings further comprises:
a first coil and a second coil wound about an axis that is perpendicular to both the axis of symmetry of the innermost ring and the axis of rotation of an axle pair of the plurality of axle pairs rotatably coupled to the innermost ring; and
a circuit electrically coupled to the first and second coil and including electrical components effective to sense current induced in the first coil and, in response to sensing current induced in the first coil, generate a corresponding current in the second coil.

6. The apparatus of claim 5, wherein a second-most inward ring of the plurality of concentric rings includes magnets positioned to induce current in the first coil responsive to rotation of the second-most inward ring relative to the innermost ring.

7. The apparatus of claim 5, wherein the first and second coils are wound in opposite directions.

8. The apparatus of claim 5, wherein the circuit comprises:
first and second transistors having the first coil coupled to a drain of the first transistor and the second coil coupled to a drain of the first transistor; and
a first capacitor coupling the first coil to a gate of the second transistor and a second capacitor coupling the second coil to a gate of the first transistor.

9. The apparatus of claim 1, wherein an outermost ring of the plurality of concentric reigns is coupled to a handle.

10. The apparatus of claim 9, wherein the handle is coupled to the outermost ring by a motor effective to oscillate the outermost ring relative to the handle.

11. The apparatus of claim 10, further comprising an alarm clock circuit coupled to the motor and including circuits effective to activate the motor at a time stored in the alarm clock.

12. The apparatus of claim 9, further comprising at least one light source embedded in the handle and oriented to illuminate the plurality of concentric rings.

13. The apparatus of claim 9, further comprising a suction cup the outermost ring being secured to the handle by engagement with the suction cop.

14. The apparatus of claim 9, further comprising a hollow and translucent sphere, the plurality of concentric rings being positioned within the sphere and the handle securing to the sphere.

15. An apparatus comprising:
a plurality of concentric rings defining a plurality of adjacent ring pairs each including an inner ring and an outer ring having an inner diameter greater than an outer diameter of the inner ring such that the inner ring is insertable and rotatable within the outer ring; and
a plurality of axle pairs including first and second axles positioned on opposite sides of the inner ring of the adjacent ring pair and defining an axis of rotation, the first and second axles rotatably coupling the inner ring to the outer ring of the adjacent ring pairs, the axis of rotation being perpendicular to axes of symmetry of both the first and second rings, a circular race defined on one of an outer surface of the inner ring and an inner surface of the outer ring, and the first and second axles being slidably coupled to the circular race.

16. The apparatus of claim 15, wherein the circular race is a groove, the first and second axles including protrusions formed on a ring positioned within the groove.

17. A method comprising:
providing a plurality of concentric rings defining a plurality of adjacent ring pairs each including an inner ring and an outer ring having an inner diameter greater than an outer diameter of the inner ring such that the inner ring is insertable and rotatable within the outer ring;
providing a plurality of axle pairs, each axle pair associated with an adjacent ring pair and including first and second axles positioned on opposite sides of the inner ring of the adjacent ring pair and defining an axis of rotation, the first and second axles rotatably coupling the inner ring to the outer ring of the adjacent ring pairs, the axis of rotation being perpendicular to axes of symmetry of both the first and second rings, the axes of rotations of the plurality of axle pairs are at non-orthogonal and non-parallel angles with respect to one another; and
applying an oscillating force to at least one of the plurality of concentric rings effective to induce rotation of one or more other rings of the plurality of concentric rings.

18. The method of claim 17, wherein the axis of rotation each axle pair of the plurality of axle pairs defines an angle between 10 and 80 degrees with respect to the axes of rotation all other axle pairs of the plurality of axle pairs.

19. The method of claim 17, further comprising:
providing in an innermost ring of the plurality of concentric rings a first coil and a second coil wound about an axis that is perpendicular to both the axis of symmetry of the innermost ring and the axis of rotation of an axle pair of the plurality of axle pairs rotatably coupled to the innermost ring;
providing in a non-innermost ring of the plurality of concentric rings first and second magnets positioned opposite one another; sensing a current in the first coil induced by rotation of the first magnet in a first direction relative to the first coil; and
inducing a current in the second coil in response to sensing the current in the first coil, the inducing the current in the second coil effective to exert a magnetic force on the second magnet, the magnetic force urging rotation of the non-innermost ring in the first direction.

20. The method of claim 17, wherein applying the oscillating force to the at least one of the plurality of concentric rings effective to induce rotation of the one or more other rings of the plurality of concentric rings comprises:
sensing occurrence of a predetermined time; and
in response to sensing occurrence of the predetermined time, activating a motor to apply the oscillating force to the at least one of the plurality of concentric rings.
